(19) United States
(12) Patent Application Publication
(10) Pub. No.: US 2006/0142471 A1
(43) Pub. Date: Jun. 29, 2006

(54) Heat resistant thermally conductive material

(76) Inventor: Takuya Shindo, Mie (JP)

Correspondence Address: Donald S Dowden;Cooper & Dunham, 1185 Avenue of the Americas, New York, NY, 10036, US

(21) Appl. No.: 10/544,168

(22) PCT Filed: Jan. 5, 2004
(86) PCT No.: PCT/JP04/00007

§ 371 Date: Jul. 28, 2005

(30) Foreign Application Priority Data
Jan. 30, 2003 (JP) 2003-022454
Sep. 3, 2003 (JP) 2003-310797

(51) Int. Cl. C08L 83/04; C08G 77/04

(52) U.S. Cl. 524/588; 528/34

(57) ABSTRACT

The object of the present invention is to provide a heat resistant thermally conductive material, to which fine powder such as dust, toner, and the like are hard to adhere, and which has good heat radiative properties. To attain this object, the present invention provides a heat resistant thermally conductive material, being made from an organic-inorganic hybrid material, which is prepared by heating a sol containing a metal or semimetal alkoxide, and an organo-silicon compound, plus a high thermally conductive filler, to gel said sol. Said organic-inorganic hybrid has excellent mold release characteristics, so that dust, toner, and the like don't easily adhere to the thermally conductive material, and if dust, toner and the like adhere to the thermally conductive material, they are easily removed therefrom. Further, said more highly thermally conductive filler imparts good heat radiative properties to said organic-inorganic hybrid.

### FIELD OF THE INVENTION

The present invention relates to a heat resistant, thermally conductive material made from an organic-inorganic hybrid material.

### BACKGROUND OF THE INVENTION

The heat resistant thermally conductive material is used in semiconductor parts, and electrophotographic parts, for instance.

Hitherto, a silicon rubber, into which a highly thermally conductive filler is mixed to impart heat resistance to the silicon rubber, has been used as said heat resistant thermally conductive material.

Patent Literature 1 Tokkohei 6-71051

Patent Literature 2 U.S. Pat. No. 2,732,792

Patent Literature 3 U.S. Pat. No. 2,755,903

Patent Literature 4 U.S. Pat. No. 2,755,904

Filler is hard to mix into said highly thermally conductive material based on silicon rubber in a high content. The thermal conductivity of said conventional highly thermally conductive material is limited to below 5 w/m·K, its common thermal conductivity being 3 w/m·K. Further, said conventional material lacks adequate heat resistance to hold up under continuous usage in an environment in which the temperature is higher than 180° C. A gel type high thermal conductive material having a thermal conductivity higher than 10 w/m·K has been proposed, but said material has problems of mechanical strength and heat resistance. Further, in a case where filler is mixed into said material in a high content, the sheet may become harder degrading its adhesive abilities with the parts, so that its heat radiative porperties degrade when used as a heat radiative material.

Said silicon material used for heat radiative material, is problematic as to whether it is adaptable to next generation element, since said silicon material has poor heat resistance, and further, high thermal conductivity has not been realized in said silicon material for above described reasons. In particular, a heat resistant roller (a fixing roller) for an electrophotographic printing machine, made of a highly thermally conductive material requires heat resistance to enable ON, and energy saving, said roller having a structure consisting of a base made of a silicon rubber to which a filler is added, and a surface layer made of fluorocarbon resin. As for said roller, there is a problem in that the amount of filler that can be added to said silicon rubber is limited, and, as a result, high thermal conductivity cannot be realized, extending the time it takes to heat said roller to a predetermined temperature, to retard instant ON.

### DISCLOSURE OF THE INVENTION

To solve these problems, the present invention provides a heat-resistant, thermally conductive material being made from an organic-inorganic hybrid material, prepared by heating a sol containing a metal or semimetal alkoxide, and an organosilicon compound, plus a highly thermally conductive filler, to gel said sol.

Said organosilicon compound is preferably organosiloxane having functional group(s) that are reactive with said metal or semimetal alkoxide at one or both ends.

Further, it is preferable that said organosilicon compound is a polyorganosiloxane having functional group(s) that are reactive with said metal or semimetal alkoxide at one or both ends, with the weight average molecular weight of said polyorganosiloxane being in the range of between 400 and 15000, or said organosilicon compound is a polyorganosiloxane having functional group(s) that are reactive with said metal or semimetal alkoxide at one or both ends, with the weight average molecular weight of said polyorganosiloxane being higher than 15000 in a case where special heat resistance is required.

Further, it is preferable that said organic-inorganic hybrid material is synthesized by the condensation reaction between the reactive functional group(s) at one or both ends of said organosilicon compound and said metal or semimetal alkoxide, accompanying hydrolysis, and said condensation reaction is preferably carried out by heating at a temperature higher than 80° C. to decrease the viscosity of said organosilicon compound.

Further, it is also preferable that the metal of said metal alkoxide is of one or more kind(s) of metal(s) selected from a group consisting of boron aluminum, silicon, titanium, vanadium, manganese, iron, cobalt, germanium, yttrium, zirconium, niobium, lanthanum, cerium, tantalum and tungsten.

Still further, it is preferable that said highly thermally conductive filler is a fine powder of one or more kind(s) of metal and/or metal oxide and/or metal nitride and/or metal carbide.

### ACTION

Said heat resistant, thermally conductive material made from said organic-inorganic hybrid improves the thermal conductivity of said organic-inorganic hybrid and imparts a heat radiative property to said organic-inorganic hybrid. In particular in a case where fine grain ceramic such as boron nitride or the like is added to said organic-inorganic hybrid, a material having a high heat radiative property is obtained.

### EFFECT OF THE INVENTION

Into said heat resistant thermal conductive material, a high content of highly thermally conductive filler can be mixed. The parts made of said heat resistant thermal conductive material, having low hardness, have strong heat resistance for a temperature higher than 200° C.

### BRIEF DESCRIPTION OF THE DRAWING

FIG. 1 shows a cross sectional view of the heat radiating apparatus of IC package.

### EXPLANATION OF NUMBER

4 heat radiative film

### PREFERRED EMBODIMENT FOR PRACTICE OF THE INVENTION

The present invention is precisely described below.

A heat resistant thermally conductive material of the present invention is made from an organic-inorganic hybrid prepared by the gelation of sol containing metal or semimetal alkoxide, organosilicon compound, and a highly thermally conductive filler.

(Metal Or Seimimetal Alkoxide)

The metal or semimetal of metal or semimetal alkoxide used in the present invention is such as aluminium, silicon, titanium, vanadium, manganese, iron, cobalt, zinc, germanium, yttrium, zirconium, niobium, lanthanum, cerium, cadmium, tantalum, and tungsten, or the like, said metals or semimetals being able to produce alkoxide. In particular, preferable metals may be such as titanium, zirconium, and silicon.

Any kind of alkoxide such as methoxide, ethoxide, propoxide, butoxide or the like may be used in the present invention, and said metal or semimetal alkoxide preferably being chemically modified with a chemical modifier such as acetoacetate, such as methyl acetoacetate, ethyl acetoacetate, isopropyl acetoacetate or the like.

(Organosilicon Compound)

As said organosilicon compound of the present invention, such as dialkyl dialkoxysilane, preferably polyorganosiloxane, having functional group(s) at one or both ends reactive with said metal or semimetal alkoxide such as polydimethyl siloxane having a silanol group at one or both end may be used. Said dialkyldialkoxysilane may be such as dimethyldimethoxysilane, dimethyldiethoxysilane, dimethyldipropoxysilane, dimethyldibutoxysilane, diethyldimethoxysilane, diethyldiethoxysilane, diethyldipropoxysilane, diethyldibutoxysilane, dipropyldimethoxysilane, dipropyldiethoxysilane, dipropyldipropoxysilane, dipropyldibutoxysilane, diphenyldimethoxysilane, diphenyldiethoxysilane, diphenyldipropoxyeilane, diphenyldibutoxysilane and the like.

Generally, polyoriganosiloxane having a weight average molecular weight in the range between of 400 and 80000 is used in the present invention, and considering heat resistance, polyorganosiloxane having a weight average molecular weight of higher than 15000 is preferable.

In a case where molded organic-inorganic hybrid is used under the conditions at a low temperature of below 200° C., polyorganosiloxane having a weight average molecular weight in the range between of 400 and 15000 is preferably used. Under temperature conditions higher than 200° C., polyorganosiloxane, having a weight average molecular weight in the range of 15000 and 80000 is preferably used.

In a case where the weight average molecular weight of said organosiloxane is over 15000, said organosiloxane will become viscous, making a synthesis of said organosiloxane difficult, so that dilution with solvent may be necessary.

In a case where the weight average molecular weight of said organosiloxane is over 80000, the viscosity of sol may be excessively high, deteriorating its workability.

Further, in a case where the weight average molecular weight of said organopolysiloxane is below 15000, the resulting organic-inorganic hybrid material has poor heat resistance.

The functional group(s) at one end or both ends of said polyorganosiloxane, being reactive with said metal or semimetal alkoxide may be such as functional groups whose chemical formulae 1 to 13 are shown below. R and R′ in the chemical formulae indicate methylene alkylene, and alkyl.

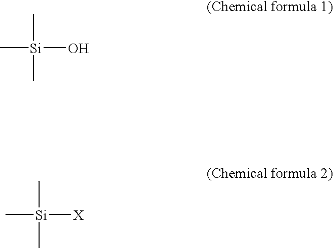

Where X=alkoxyl group such as —OCH₃, —OC₂H₅, or the like
halogen atom such as —Cl, Br, or the like

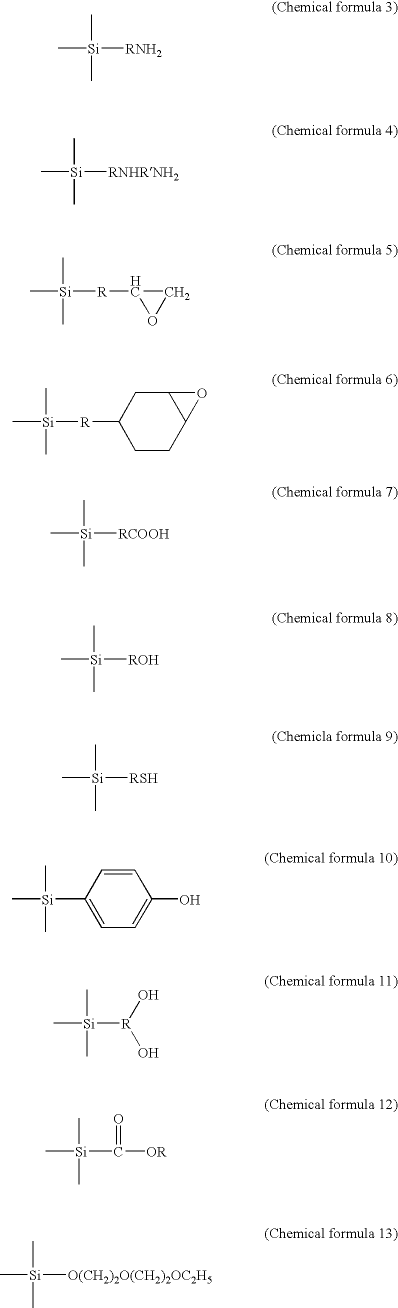

Said polyorganosiloxane having said functional group reacts smoothly with said metal or semimetal alkoxide.

(Highly Thermally Conductive Filler)

Said high thermal conductivity fillers used in the present invention include as metal powders of copper, aluminum, silver, stainless steel, and the like, metal oxide powders of iron oxide, aluminum oxide, titanium dioxide, silicondioxide, cerium oxide, and the like, metal nitride powders of boron nitride, aluminum nitride, chromium nitride, silicon nitride, tungsten nitride, magnesium nitride, molybdenum nitride, lithium nitride, and the like, metal carbide powders of silicon carbide, zirconium carbide, tantalum carbide, titanium carbide, iron carbide, boron carbide and the like, and particle sizes of said fillers may be in the range of between about 0.1 μm and 30 μm.

(Preparation Of Organic-Inorganic Hybrid Material)

Said organic-inorganic hybrid material is synthesized by the condensation reaction between the reactive functional group(s) at one or both ends of said organosilicon compound, and said metal or semimetal alkoxide, accompanying hydrolysis. Said condensation reaction may be carried out by heating at a temperature of higher than 80° C. to decrease its viscosity.

To prepare said organic-inorganic hybrid material, a predetermined metal or semimetal alkoxide hydrolysate is reacted with an organic component such as said organosilicon compound to prepare an organic-inorganic hybrid sol. Said organic component may be mixed into said alkoxide before or after hydrolysis. Concretely, said metal or semimetal alkoxide, or if desirable modified metal or semimetal alkoxide with a chemical modifier is dropped in a solution of said organosilicon compound.

The solvent generally used for said solution of said organosilicon compound includes an alcohol such as methanol, ethanol, or the like, or further, acetone, toluene, xylene, tetrahydrofuran, or the like.

Further, said solution of said organosilicon compound is preferably heated for distillation treatment to remove any excess water or low molecular weight components. By removing said water, when said metal or semimetal alkoxide is added to said organosilicon compound, the hydrolysis of said metal or semimetal alkoxide by the remaining water can be prevented, so that the dropping speed of said metal or semimetal alkoxide can be increased to shorten the time synthesis time for said organic-inorganic hybrid, effectively solving the problems of sticking of said organic-inorganic hybrid caused by the remaining low molecular weight components, and the degradation of its mechanical strength, and the like.

Said organosilicon compound solution is preferably acid treated by adding hydrochloric acid, sulfuric acid, nitric acid, phosphoric acid, acetic acid, or the like.

Usually said acid may be added to said organosilicon solution in such a manner that the pH of said organosilicon compound solution ranges between 4 and 7.

In a case where said metal alkoxide, which is added to said organosilicon compound solution, is modified with a chemical modifier, said chemical modifier may be added to said metal alkoxide in an amount of less than 1.5 moles, preferably at 0.5 mole or more per mole of said metal alkoxide.

Generally, said metal or semimetal alkoxide may be added to said organosilicon compound at a molar ratio of between 1:0.1 and 1:10. Further, the content of said organosilicon compound is preferably about 80% by volume for said metal or semimetal alkoxide.

In a case where the content of said metal or semimetal alkoxide is higher than said ratio, said metal or semimetal component produces a particle block, and swells or pores are formed in the resulting organic-inorganic hybrid material, and in a case where the content of said organosilicon compound is higher than said ratio the synergy effect of the inorganic component does not occur, so that the properties of the resulting organic-inorganic hybrid may approach those of the organic compound.

To said organic-inorganic hybrid sol, said highly thermally conductive filler may be added. Said highly thermally conductive filler is generally added to said organic-inorganic hybrid in an amount ranging between about 0.5 and about 90% by mass. Since said organic-inorganic hybrid sol of the present invention has good dispersability for a filler, said highly thermally conductive filler is easily and uniformly dispersed in said sol.

Further, the fine particles of said highly thermally conductive filler, having a particle size of about a few μm, act as a thickener, said fine particles increasing the viscosity of said sol, and imparting a thixotropic property to its viscosity. Accordingly, a thick film of said sol is easily formed.

Besides said highly conductive filler, if desirable, an antioxidant, ultraviolet absorber, preservative, viscosity controlling agent, or the like may be further added to said organic-inorganic hybrid sol.

The resulting organic-inorganic hybrid sol has a long pot life without becoming milky.

Generally to prepare said organic-inorganic hybrid from said organic-inorganic sol, said sol is coated on a base material, and then heated to gel.

Said sol is also molded into a desirable shape by casting, extrusion molding, and the like, then baked under a proper atmosphere. Further, said sol is coated on the surface of parts such as a core or base material, and then heated to gel, forming said organic-inorganic hybrid, having the desired shape on said core or base material. The heat conditions are generally at a temperature in the range of between 60° C. and 450° C., for 20 seconds to 8 hours.

(Heat Resistant Thermally Conductive Material)

Said heat resistant thermally conductive material of the present invention is made of said organic-inorganic hybrid material. Said heat resistant thermally conductive material of the present invention has excellent heat resistance, electroconductivity, elasticity, and adhesion properties.

EXAMPLES to describe the present invention more concretely are given below.

### EXAMPLES

### Example 1

First, 0.08 mole of hydrochloric acid was added to a solution containing 0.5 mole of phenyl polydimethylsiloxanes, having silanol groups at both ends (GE TOSHIBA SILICON CO., LTD. YF 3804 MW=3000), and 2.5 moles of absolute ethanol, to prepare solution A. The pH of the resulting solution A was 5.

Then, 1.0 mole of titanium isopropoxide mixed with 1.5 moles of ethyl acetate was chemically modified under nitrogen gas atmosphere to prepare solution B. Said solution B was then dropped into said solution A while agitating to prepare a sol.

Said sol was coated on a metal panel by dipping, and prebaked at 80° C. for 1 hour, after which the temperature was raised to 250° C. for 2 hours to obtain a heat resistant insulation film having a thickness of 100 μm.

The electric properties of the resulting film were estimated, and as a result, the volume resistivity of said film was 10¹⁵·Ω cm at room temperature and 10¹³·Ω cm at 200° C., so that it was confirmed that the insulation properties of said film did not decrease at a high temperature.

### Example 2

An amount of 0.08 mole of hydrochloric acid was added to a solution containing 0.8 mole of dimethyl ethoxysilane and 2.5 moles of absolute ethanol to prepare solution A. The pH of the resulting solution A was 5.

A solution containing 0.5 mole of Siethoxide, 0.5 mole of isopropoxide and 4 moles of absolute ethanol was prepared to be solution B.

Said solution B was then dropped into said solution A while agitating to prepare a sol. Alumina having a particle size in the range of between 0.5 and 20 μm was added to the resulting sol in an amount of 85% by mass to the organic-inorganic hybrid contained in said sol. Said sol was then put into a PFA laboratory dish, and prebaked at 150° C. for 3 hours, after which the temperature was raised to 250° C. A heat resistant sheet having a thickness of 0.2 mm was obtained.

The basic properties of the resulting sheet were estimated, and as a result, it was estimated that the contact angle was 110° C., the thermal conductivity 3 W/m·K, with the heat resistant property from the TG-DTA being 330° C.

### Comparison 1

A two-component curing type silicon rubber was coated onto a metal panel with a doctor blade, and then said silicon rubber was crosslinked with a peroxide in a continuous furnace, and after secondary curing, an isolation film having a thickness of 0.3 mm was prepared.

The isolation property of the resulting film was estimated, and as a result, the volume resistivity of said film decreased to 10¹²·Ω cm at 200° C., and it was confirmed that said film had a problem of the isolation property.

Alumina was added to said silicon rubber material, and blended in with a 3 roll mixer. The resulting rubber material was extruded using a T-die, and a sheet was molded. Said rubber material of the resulting sheet was crosslinked with a peroxide in a continuous furnace, and after secondary curing, a thermally conductive sheet was prepared. Further, the amount of alumina added to said sheet was maximum at 75% by mass.

The thermal conductivity of said sheet was 1.4 W/m·K, and the heat resistance 180° C., said sheet having a lower heat radiating property than that of said film of EXAMPLE 1.

### Example 3

A solution containing 0.35 mole of polydimethylsiloxane having a silanol group at both ends (weight average molecular weigh 6000, GE TOSHIBA SILICON CO. LTD.) and 2.0 moles of absolute ethanol was prepared and further 0.03 mole of hydrochloric acid was added to said solution. The resulting solution was heated while agitating to remove water and low molecular weight components to prepare a solution of polydimethylsiloxane having silanol groups at both ends. The pH of said solution was 5.

On the other hand 1 mole of titanium tetraisopropoxide and 0.5 mole of ethyl acetoacetate were reacted together to prepare a chemically modified titanium tetraisopropoxide with ethylacetoacetate. The resulting chemically modified titanium tetraisopropoxide was dropped into said solution of polydimethyl siloxane having silanol groups at both ends, while agitating, to prepare a sol. Boron nitride powder having an average particle size of 3 μm was added to the resulting sol in an amount of 80% by mass for the organic-inorganic hybrid in said sol.

The resulting hybrid into which the boron nitride was mixed was coated onto the surface of a metal roll with a dispenser coat, to form a film having a thickness of 0.6 mm. The resulting roll was then heated at 80° C. for 30 minutes, and then at 180° C. for 2 hours, then further at 200° C. for 30 minutes to obtain a fixing roll onto which an organic-inorganic hybrid film having a thickness of 0.6 mm was formed.

Performances of the resulting fixing roll were evaluated and as a result, said fixing roll has a high water repellency, as shown by the contact angle of 112°, and a smooth surface, as shown by the surface roughness of R_{z}=0.1 μmK.

Further, in the heat resistance test at 200° C., for 500 hours, said roll shows no change its the mechanical properties. As a result of the printing evaluation of the fixing unit using said roll, a good quality of picture was obtained. Further, the time required to be heated to a predetermined temperature, was shortened to ⅔.

### Comparison 2

Alumina was added to a silicon rubber, and the resulting silicon rubber compound was coated onto the surface of a metal roll with a flow coater to form a film having a thickness of 0.6 mm, and the resulting coated roll was heated at 180° C. and after secondary curing, a silicon rubber roll was prepared.

Said roll was covered with a PFA tube to obtain a fixing roll. Said roll satisfied present fixing property required but had a problem with picture quality caused by the hardness of the PFA surface layer, and further had a poor thermal conductivity, and the heat-up time of said roll was inferior to that of the roll of EXAMPLE 3.

### Example 4

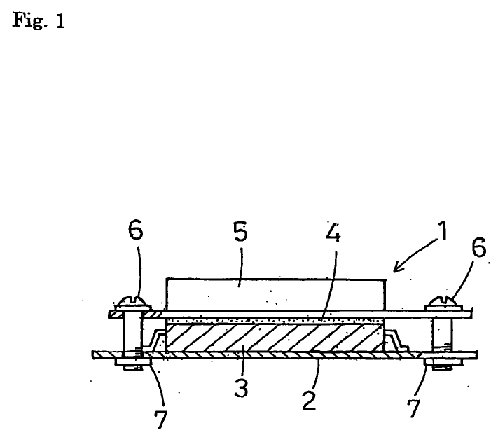

FIG. 1 shows an embodiment of the heat radiating apparatus of the IC package. Said heat radiating apparatus (1) consists of a printed circuit base panel (2), a central processing unit (CPU) (3) set on said printed circuit base panel (2), a heat radiative film (4) formed on said CPU (3), and a heat radiative panel (5) put over said heat radiative film (4), and said CPU (3) and said heat radiative film (4) were fixed between said base panel (2) and said heat radiative panel (5) by bolts (6) and nuts (7).

Eighty percent by mass of alumina was added to said gel synthesized in EXAMPLE 3, and the resulting gel compound was mixed with a propeller mixer. The resulting gel was then coated onto the under side of said heat radiative panel (5) (said under side coming into contact with said CPU (3) by screen printing, after which the resulting film was baked under the same conditions as in EXAMPLE 3 to form a film having a thickness of 0.1 mm.

Said heat radiating apparatus (1) had an excellent heat radiative effect, a small amount of heat accumulation, and excellent durability. Further, said heat radiating apparatus, exhibiting low hardness and moderate tackiness, had an excellent adhesion, so that said heat radiating apparatus can be an excellent heat radiating material.

### Example 5

An amount of 0.35 moles of a polydimethyl siloxane having silanol groups at both ends (XF 3905, average weight molecular weight 2000) was heated at 80° C., to prepare a dimethylsiloxane solution.

On the other hand, 1 mole of titanium tetraisobutoxide and 0.5 mole of ethylacetoacetate were reacted together under nitrogen gas atomosphere to prepare a chemically modified titanium tetraisobutoxide with ethylacetoacetate. The resulting chemically modified titanium tetraisobutoxide was dropped in said dimethylsiloxane solution and mixed to prepare a sol. Twenty percent by mass of boron nitride (SP-2, DENKI KAGAKU KOGYO K. K.) and 3% by mass of siliconoxide (R972, R200, RX200, R50, NIPPON AEROSIL CO., LTD.) were each added to said sol, the resulting mixtures then being mixed by the propeller mixer.

After mixing foams were removed from each mixture by using a vacuum, the resulting sols were each poured into molds made of polytetrafluoroethylene, after which said sols were each baked at 120° C. for 4 hours, 200° C. for 4 hours, and then 275° C. for 30 minutes, to prepare thermally conductive sheets. The thickness of the resulting sheets was each 0.6 mm. The modulus of elasticity and tensile strength of said sheet were determined. The results are shown in Table 1.

TABLE 1

| | | Thermally conductive sheet | | | |
|---|---|---|---|---|---|
| | | 1 | 2 | 3 | 4 |
| Boron nitride | SP-2 | 20 wt % | 20 wt % | 20 wt % | 20 wt % |
| Silicon dioxide | R972 | 6 wt % | | | |
| | R200 | | 6 wt % | | |
| | RX200 | | | 6 wt % | |
| | R50 | | | | 6 wt % |

| | | | | |
|---|---|---|---|---|
| Modulus of elasticity (N/mm²) | 2.00 | 2.76 | 1.93 | 1.61 |
| Tensile strength (N/mm²) | 3.04 | 2.67 | 1.78 | 2.80 |

### POSSIBILITY OF INDUSTRIAL UTILITY

Said heat resistant thermally conductive material, made of said organic-inorganic hybrid material of the present invention, may be applied particularly in the heat resistant roller used in an electrophotographic printing machine, the heat resistant thermally conductive parts and the heat radiating material used as electric parts, and the like.

1. A heat-resistant, thermally conductive material being made from an organic-inorganic hybrid material, prepared by heating a sol containing a metal or semimetal alkoxide, and a polyorganosiloxane having functional group(s) reactive with said metal or semimetal alkoxide at one or both ends, with the weight average molecular weight of said polyorganosiloxane being higher than 15000, plus a highly thermally conductive filler, to gel said sol.

2. (canceled)

3. (canceled)

4. (canceled)

5. A heat-resistant, thermally conductive material in accordance with claim 1, wherein said organic-inorganic hybrid material is synthesized by the condensation reaction between the reactive functional group(s) at one or both ends of said organosilicon compound and said metal or semimetal alkoxide, accompanying hydrolysis.

6. A heat-resistant, thermally conductive material in accordance with claim 1, wherein the metal of said metal alkoxide is of one or more kind(s) of metal(s) selected from a group consisting of boron aluminum, silicon, titanium, vanadium, manganese, iron, cobalt, zinc, germanium yttrium, zirconium, niobium, lanthanum, cerium, cadmium, tantalum and tungsten.

7. A heat-resistant, thermally conductive material in accordance with claim 1, wherein said highly thermally conductive filler is a fine powder of one or more kind(s) of metal and/or metal oxide and/or metal nitride and/or metal carbide.

8. A heat-resistant, thermally conductive material in accordance with claim 2, wherein the metal of said metal alkoxide is of one or more kind(s) of metal(s) selected from a group consisting of boron aluminum, silicon, titanium, vanadium, manganese, iron, cobalt, zinc, germanium, yttrium, zirconium, niobium, lanthanum, cerium, cadmium, tantalum and tungsten.

9. A heat-resistant, thermally conductive material in accordance with claim 2, wherein said highly thermally conductive filler is a fine powder of one or more kind(s) of metal and/or metal oxide and/or metal nitride and/or metal carbide.

10. A heat-resistant, thermally conductive material in accordance with claim 3, wherein said highly thermally conductive filler is a fine powder of one or more kind(s) of metal and/or metal oxide and/or metal nitride and/or metal carbide.
